(19) United States
(12) Patent Application Publication
(10) Pub. No.: US 2005/0193351 A1
(43) Pub. Date: Sep. 1, 2005

(54) Varying-content menus for touch screens

(75) Inventor: Tomi Huoviala, Helsinki (FI)

Correspondence Address: COHEN, PONTANI, LIEBERMAN & PAVANE;Suite 1210, 551 Fifth Avenue, New York, NY, 10176, US

(73) Assignee: Myorigo, L.L.C.

(21) Appl. No.: 11/058,907

(22) Filed: Feb. 16, 2005

Related U.S. Application Data
(63) Continuation of application No. PCT/FI02/00675, filed on Aug. 16, 2002.

(51) Int. Cl. G06F 3/00

(52) U.S. Cl. 715/815; 715/800; 715/810; 715/840; 715/864

(57) ABSTRACT

A method and system implementing menus for touch screens. A touch screen shows at least one menu that can be touched with a probe, which is the user's finger, for example. When the touch time of a menu reaches a predetermined time limit, a user is preferably given feedback indicating that the content of the menu will be varied. Feedback may be visual, audible, or haptic. There are basically two ways to vary the content of a menu. The menu can be enlarged from its default size, so that it contains a greater number of menu options. Alternatively, the content of the menu can be varied so that the size of the menu is constant but at least one of the menu options shown is replaced by another menu option.

### CROSS REFERENCE TO RELATED APPLICATION

This application is a continuation of International Application No. PCT/FI2002/000675 filed on Aug. 16, 2002.

### BACKGROUND OF THE INVENTION

1. Field of the Invention

The present invention relates generally to graphical user interfaces and menus used in small-sized touch screens.

2. Description of the Related Art

The data-storing and data-processing capacity of small-sized devices has been developing remarkably during the past ten years. Terminal equipment, such as mobile phones and personal digital assistants (PDAs) can run relatively complicated applications, such as email and word processing. When equipment is small-sized, its display screen may be tiny. An application used in such a device may include a user interface composed of number of menus and menu options. Then the usability of the user interface is often weak, because the menus and menu options do not fit properly on the tiny display space. The same kind of drawback is also related to the displays of laptops and workstations. The following example illustrates how the drawback is solved in one mouse-operated application.

FIG. 1A shows the pull-down menu of Microsoft Word 2000. When a user moves the cursor of a mouse 101 so that it points to “File” option in the pull-down menu 102 and clicks the left mouse button, Microsoft Word opens the “File” menu.

FIG. 1B shows the “File” menu 103 of Microsoft Word 2000 in its default size. At first, the “File” menu includes six menu options: “New, “Open”, “Close”, “Save”, “Save As, and “Print”. If the user does not choose any of those menu options, after a few seconds, the “File menu” automatically enlarges so that it includes more menu options.

FIG. 1C shows the “File” menu 103 of Microsoft Word 2000 after it has been enlarged from its default size. For example, the enlarged “File” menu may include the six above-mentioned menu options and seven other menu options 104-110.

Thus, in some mouse-operated applications each menu automatically enlarges after a predetermined time limit T1. In Microsoft Word the time limit T1 is about six seconds.

EP0651543 teaches improved zoom and pan functions for touch screens. Graphic image files can be stored in a memory of a hand-held communicator and displayed on a touch screen. A zoom function magnifies the area of a graphic image. When the zoom function is selected and a user touches an image on the screen, a magnification frame appears around the touched point on the screen. When the user removes his/her finger from the screen, the area within the frame is magnified. In other words, the image is shown in a bigger size. A pan function allows a user to shift an image on the screen. The user can pan the image by touching the image, keeping his/her finger in contact with the screen, and moving the image from one position to a new position. In other words, this is a drag-and-drop function for touch screens.

The prior art menu systems for touch screens are static, so that the content and size of menus are always the same. Menu systems should be more dynamic and still easy to use.

### SUMMARY OF THE INVENTION

One aspect of the invention is to enhance the usability of menu systems intended for small-sized touch screens. Another aspect of the invention is to replace the buttons which are usually placed in a device with graphical buttons or menu options on a touch screen.

The invention comprises a method and a system implementing menus for touch screens. A touch screen shows at least one menu that can be touched by a probe. The probe may be the user's finger or a special pointing stick. The touch screen must be adapted to measure the length of time a user touches the menu area.

When the touch time of a menu reaches a predetermined time limit T1, the user is preferably given a feedback indicating that the content of the menu will be changed. The said feedback and other possible feedback may be visual, audible, or haptic. There are basically two embodiments for varying the content of a menu.

In the first embodiment the menu is enlarged from its default size. The menu can be enlarged several times.

In the second embodiment the content of the menu is changed so that the size of the menu is constant but at least one menu option shown is replaced by another menu option. Also in this embodiment the content of the menu can be changed several times if the probe is continuously kept on the menu area.

A touch screen may show a number of menus. A user can select one of these menus by pressing with a probe a menu or an icon related to the said menu by a probe. If the user moves the probe within the menu area and releases the probe over one of the menu options, a function related to the said menu option is performed. However, if the user keeps the probe on 1) the surface of the touch screen and 2) on the menu area for the time limit T1, the content of the menu starts to vary. The content of the menu varies within a predetermined time limit T2. After that the user may be given feedback indicating that all menu options have been shown.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

The invention is described more closely with reference to the accompanying drawings, in which

FIG. 1A shows the pull-down menu of Microsoft Word 2000;

FIG. 1B shows the “File” menu of Microsoft Word 2000 in its default size;

FIG. 1C shows the “File” menu of Microsoft Word 2000 enlarged from its default size;

FIG. 2A shows the operation logic of the method;

FIG. 2B shows feedback related to the method;

FIG. 3A shows another email icon;

FIG. 3B shows another example of an email icon;

FIG. 3C shows an email menu with a title and a default menu option;

FIG. 4A shows an email menu in its default size;

FIG. 4B shows the email menu enlarged from its default size;

FIG. 5A shows a fixed-size email menu;

FIG. 5B shows the fixed-size email menu with one new menu option.

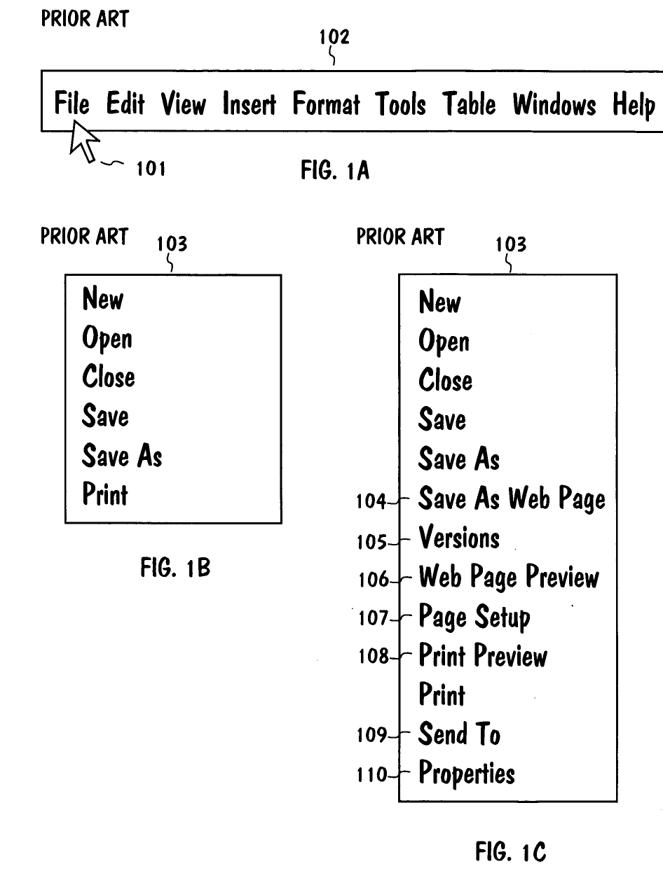

### DETAILED DESCRIPTION OF THE PRESENTLY PREFERRED EMBODIMENTS

The invention comprises the method and system implementing menus for touch screens. A touch screen shows one or more menus, each of which contains at least one menu option.

A menu can be touched by a probe which may be, for example, the user's finger or a pointing stick. Each menu option shown in the menu is mapped to a certain function. A user can select a menu option by keeping the probe on the surface of the touch screen, moving the probe, and releasing it in a position over the menu option which he/she wants to select. If the user does not want to select any menu option, he/she keeps the probe on the surface of the touch screen and moves it to an area outside of the menu area.

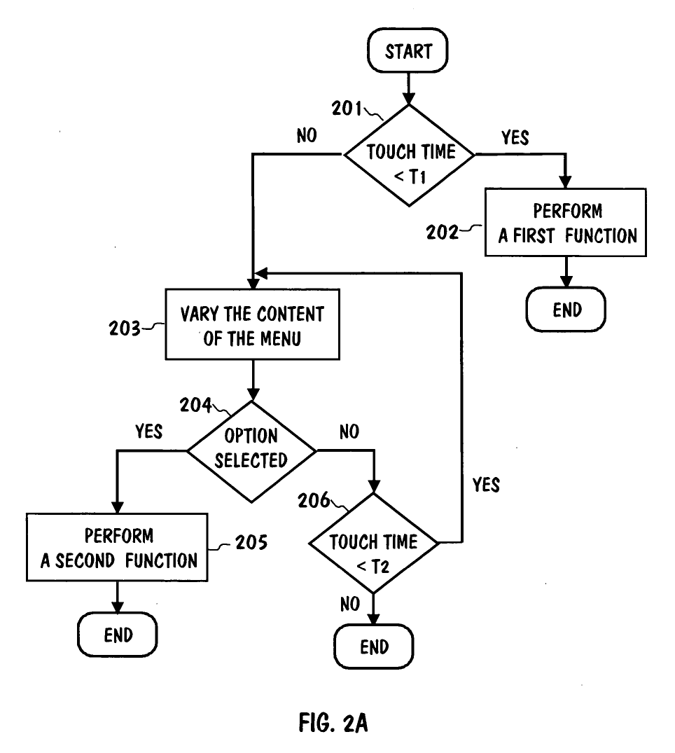

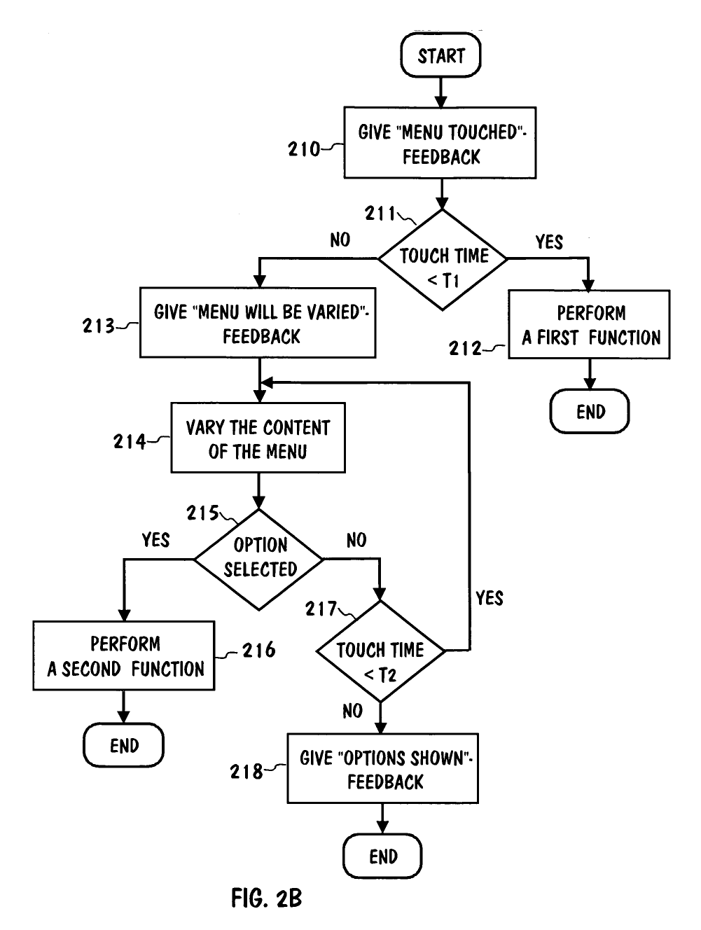

FIG. 2A shows the operation logic of the method. The operation of the method starts when a user touches with a probe a menu or an icon related to the menu. The operation ends whenever the user moves the probe to an area outside of the menu area. This possibility is omitted from FIG. 2A to simplify the description. The touch time of a menu is measured from the point in time when a user touches a menu with a probe, and the touch time ends when the user 1) moves the probe to an area outside of the menu area or 2) selects a menu option by releasing the probe over the said menu option. If the touch time is shorter than T1, a default function is performed 202. If the touch time reaches the time limit T1, the content of the menu is changed 203 at least once. The content can be varied by enlarging the size of the menu and showing a greater number of menu options in the enlarged menu. Alternatively, the content can be varied by changing at least one menu option to another menu option. The user may select 204 a menu option by releasing the probe from the surface of the touch screen over the menu option. Then a function mapped to the said menu option is performed 205. Otherwise, if the user has not selected any menu option, the touch time is compared 206 to the time limit T2. If the touch time has reached the time limit T2, the content of the menu stops changing. Otherwise, if the time limit T2 is not reached, the content of the menu may be changed again 204. This step is optional, i.e. it is also possible that the content of the menu is changed only once.

FIG. 2B shows three kinds of feedback 210, 213, and 218 which the method may give to the user of a touch screen. It is also possible to relate some subset of said feedback to the method. Each feedback may be, for example, a visual effect, a tone, or a haptic response. When a user touches the menu by a probe, the user is given the first feedback 210. Feedback 210 indicates to the user that a program controlling the touch screen has detected the user's touch. As in FIG. 2A, the touch time is measured from the point in time when the user touches with a probe the menu or a certain icon related to the menu, and the touch time ends when the user 1) moves the probe outside the menu area or 2) selects a menu option by releasing the probe over the said menu option. The touch time is compared 211 to the time limit T1. If the touch time is shorter than T1, a default function is performed 212. If the touch time reaches the time limit T1, the user is given feedback 213 indicating that the program controlling the touch screen will vary the content of the menu. After feedback 213 the content of menu is changed 214. If the user selects 215 a menu option, a function mapped to the said menu option is performed 216. Otherwise, the touch time is compared 217 to the time limit T2. If the touch time reaches the time limit T2, the user is given feedback 218 indicating that all menu options have been shown. If the time limit T2 is not reached, the content of the menu may be changed again 214. Though not shown in FIG. 2B, it is possible to give feedback 213 again to the user before varying the content of the menu.

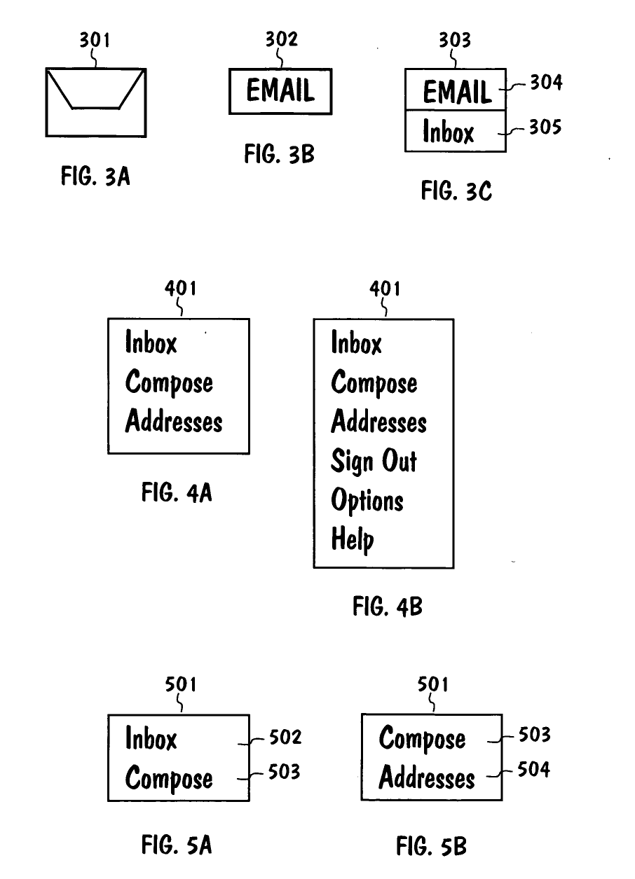

FIG. 3A shows an example of an email icon 301. The operation of the method starts when a user touches the email icon 301 symbolizing a letter.

FIG. 3B shows another example of an email icon 302. In this case, the email icon 302 is a text “EMAIL”.

FIG. 3C shows an email menu 303 with the title “EMAIL” 304 and the default menu option “Inbox” 305. If a user touches the email menu 303 and releases the probe within the predetermined time limit T1, the default function 202 shown in FIG. 2A or the default function 212 shown in 2B is performed. In FIG. 3C the default function is showing the inbox to the user.

When comparing the icons 301 and 302 with the menu 303, we can perceive that their purposes are the same. If the icons 301 or 302 or the menu 303 is touched within the time limit T1, the default function is performed. Therefore, in the patent claims, the term “menu” here may as well refer to a possible icon related to a menu.

The following example describes how the content of a menu can be changed by increasing the number of menu options and thus enlarging the menu size.

FIG. 4A shows an email menu 401 in its default size. The email menu contains the menu options “Inbox”, “Compose”, and “Addresses”.

FIG. 4B shows the same email menu 401 enlarged from its default size. The enlarged menu contains three new menu options: “Sign Out”, “Options”, and “Help”.

The following example describes how the content of a menu can be varied by changing one menu option to another menu option. Of course, it is also possible to vary the content of a menu by changing several menu options to other menu options.

FIG. 5A shows a fixed-size email menu 501. The email menu 501 contains the menu options “Inbox” 502 and “Compose” 503.

FIG. 5B shows the same email menu 501 with a new menu option. Now the menu option “Inbox” 502 is omitted from the menu 501, and the menu option “Compose” 503 is moved to the first position of the menu. The new menu option “Addresses” 504 is located in the second position of the menu. If a user does not select either of the menu options “Compose” or “Addresses” the content of the menu is then again scrolled as follows: the menu option “Compose” 503 is omitted from the menu, the menu option “Addresses” 504 is moved to the first position of the menu 501, and a new menu option “Sign Out” is located in the second position of the menu.

In the above examples menu options are texts, but they can be any visual item. Menu options may appear on the screen in groups. The menu options can be grouped in the menu vertically, as in FIG. 4A and 4B, or horizontally, or in some other way.

The content of a menu can be varied in accordance with the touch time. The time limits T1 and T2 may be fixed, or they may be adjustable so that a user can set the time limits T1 and T2. Alternatively, the content of a menu can be changed taking into account whether the user merely touches the surface of a touch screen with a probe or presses down hard. Thus, when the user presses hard the surface, the content of the menu will be changed more rapidly.

Though the examples presented above are related to email, the invention is not limited to email applications. The method and a system using the method can be utilized in various touch screen applications. The system is especially useful in terminal equipment. Of course, the system is adapted to simultaneously handle several of menus or icons on a touch screen.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A method for implementing a menu comprising at least two menu options, of which at least one is omitted from the default content of the menu when showing the menu on a touch screen,
characterized by the step of:
measuring a touch time used to touch the menu with a probe,
and when the probe is kept on the area of the menu and the touch time reaches a time limit T1,
varying the content of the menu at least once within a second time limit T2 by adding at least one menu option to the content of the menu, wherein the measurement of the time limit T1 and the time limit T2 starts from the point in time when the probe touches the menu.

2. The method as described in claim 1, characterized in that the content of the menu is varied more rapidly when the menu is pressed harder with the probe.

3. The method as described in claim 1, characterized in that a menu option of said menu is selectable by releasing the probe from the surface of the touch screen in a position over the menu option.

4. The method as described in claim 1, characterized in that feedback is given in response to at least one of the following events:
the menu has been touched,
the time limit T1 is reached, or
the time limit T2 is reached.

5. The method as described in claim 4, characterized in that the feedback is either a visual effect, a tone, or a haptic effect.

6. A system comprising at least two menu options, of which at least one is omitted from the default content of a menu when showing the menu on a touch screen, characterized in that the system is adapted to:
measure the touch time used to touch the menu by a probe, and when the probe is kept on the area of the menu and the touch time reaches a time limit T1,
varying the content of the menu at least once within a second time limit T2 by adding at least one menu option to the content of the menu, wherein the measurement of the time limit T1 and the time limit T2 starts from the point in time when the probe touches the menu.

7. The system as described in claim 6, characterized in that the content of the menu is varied more rapidly when the menu is pressed harder with the probe.

8. The system as described in claim 6, characterized in that a menu option of said menu is selectable by releasing the probe from the surface of the touch screen in a position over the menu option.

9. The system as described in claim 6, characterized in that feedback is given in response to at least one of the following events:
the menu has been touched,
the time limit T1 is reached, or
the time limit T2 is reached.

10. The system as described in claim 9, characterized in that the feedback is either a visual effect, a tone, or a haptic effect.

11. The system as described in claim 6, characterized in that the system is adapted to simultaneously handle several menus shown on the touch screen.

12. The system as described in claim 6, characterized in that the system is used in different types of terminal equipment.
